(19) United States
(12) Patent Application Publication
(10) Pub. No.: US 2026/0316665 A1
(43) Pub. Date: Oct. 15, 2026

(54) ADJUUSTING DEVICE

(71) Applicant: EJOT SE & CO. KG, Bad Berleburg (DE)

(72) Inventor: Jochen SCHROEDER, Bad Berleberg (DE)

(21) Appl. No.: 19/122,645

(22) PCT Filed: Oct. 20, 2023
(86) PCT No.: PCT/EP2023/079280

§ 371 Date: Apr. 18, 2025

(30) Foreign Application Priority Data
Oct. 21, 2022 (DE) 10 2022 127 959.6

(51) Int. Cl. B60Q 1/068

(52) U.S. Cl. CPC B60Q 1/0683; B60Q 2200/30

(57) ABSTRACT

The device (1) has an adjusting screw (2) mounted in predetermined adjusting direction, where the screw is in threaded engagement with a light module of a headlight for pivoting the light module around a horizontal or vertical axis. A bevel gear (9) is designed as a drive unit that is arranged at a rear end of the screw so that the bevel gear is rotatably supported on the screw. A cap-shaped transmission part (10) is provided as an additional drive unit. The transmission part is rotationally fixed with the bevel gear at one side and positively connected with the screw at another side.

This application is a national stage application filed under 35 U.S. C 371 of International Application No. PCT Application No. PCT/EP2023/079280 filed Oct. 20, 2023, which claims priority to German Patent Application No. 10 2022 127 959.6 filed Oct. 21, 2022. The disclosures of the above-referenced applications are incorporated herein by reference in their entireties.

The invention relates to an adjusting device for headlights, of the type specified in the preamble of claim 1.

As is known, an adjusting device for headlights having an adjusting screw, which is in threaded engagement with a headlight light module, is used for pivoting the latter about a horizontal or vertical axis.

An adjusting device of this type is disclosed in WO 2021/069744A1 , among others. This adjusting device comprises a locking sleeve with an output structure into which one end of the adjusting screw is inserted, as well as a drive wheel which is mounted on the locking sleeve from the end facing away from the adjusting screw and engages with it such that it is held in place against the mounting direction. The latching structure of the latch sleeve is formed at the end of the latch sleeve facing away from the adjusting screw. The locking structure forms a positive connection with the drive wheel. The locking sleeve engages around support structures of the adjusting screw in the axial direction, with the support structures being held in place with a radially positive fit by the attached drive wheel, thus preventing the support structures from loosening. The drive wheel thus forms a securing means for the support structures.

A disadvantage of the prior art adjusting device is that, when a torque is applied to the drive structure of the drive wheel, a force will act on the locking sleeve in a direction opposite to the mounting direction of the drive wheel, i.e. the component that is intended to prevent the support structures from loosening is subjected to a force that acts in an unlocking direction. In order to prevent unlocking during operation, this must be taken into account in the design and may result in increased mounting forces in that an appropriately dimensioned locking structure is provided.

Furthermore, two transfer structures are required for transferring an external torque from the drive wheel to the adjusting screw.

It is the object of the invention, therefore, to further improve on an adjusting device of the type specified in the preamble of claim 1 in such a way that it allows simple installation while avoiding the disadvantages mentioned above.

This object is accomplished by the characterizing features of claim 1 in conjunction with the features of its preamble.

The dependent claims relate to advantageous further embodiments of the invention.

In a known manner, an adjusting device for headlights comprises an adjusting screw assembly, comprising an adjusting screw having a screw central axis. The adjusting screw has a front and a rear end. The screw central axis naturally runs lengthwise through the adjusting screw.

The adjusting screw assembly also comprises a drive element. The drive element has a main body formed in one piece. The main body has a driving structure and a driven structure for the transmission of torque. The driving structure and the driven structure have a common axis of rotation around which the driving structure and driven structure rotate. The driving structure is located radially outside the driven structure, i.e. further away from the axis of rotation. This allows a rotational movement to be transmitted to the adjusting screw from radially outwards to radially inwards.

The drive element engages around the adjusting screw such that the driven structure is positively coupled to a screw driving structure of the adjusting screw in the direction of rotation, with the axis of rotation and the screw center axis being coaxial. This allows a torque to be transmitted from the driven structure to the adjusting screw.

The adjusting screw has an adjusting screw axial support structure and the drive element has a drive element axial support structure. The adjusting screw axial support structure and the drive element axial support structure are in engagement, at least in a securing position of the screw assembly, such that the drive element axial support structure and the adjusting screw axial support structure counteract an axial relative movement between the adjusting screw and the drive element, at least in one direction of movement.

Furthermore, the adjusting screw assembly comprises a securing element. The securing element is designed to be axially slidable relative to the drive element, at least from an installation position into a securing position. When the securing element is in the securing position, the adjusting screw assembly according to the invention is in the securing position.

The securing element has a securing region, particularly at an axial end thereof. In the securing position, the securing region of the securing element positively engages around the at least one drive element axial support structure in the radial direction at least in regions such that the retaining force imparted by the adjusting screw axial support structure and the drive element axial support structure is increased at least in an axial direction with respect to the retaining force imported in the installation position. For example, the retaining force in the installation position can result from a resiliently biased locking engagement between the adjusting screw axial support structure and the drive element axial support structure, and the retaining force in the securing position can result from a pure positive-locking fit. In this case, the retaining force corresponds to the force required to break the form fit. The force required to overcome the bias is less than the force required to break the form fit.

According to the invention, the securing element is arranged relative to the drive element in such a way that the securing region is located radially between the driving structure and the drive structure.

The one-piece design of the driving and driven structures ensures that a torque applied externally by the driving structure can be transmitted directly from the drive element to the adjusting screw.

The inventive assembly thus ensures that the securing element is not loaded with an axial force during the transmission of rotational movement from the driving structure to the driven structure, which force would cause relative movement of the securing element with respect to the drive element, namely an axial movement out of the securing position. Consequently, this axial force no longer needs to be taken into account when designing the adjusting screw assembly, which means that lower installation forces can be achieved.

Preferably, the securing element is linearly guided with respect to the drive element, in particular with respect to the main body of the driving body. This achieves positional accuracy in the circumferential direction between the installation position and the securing position.

The securing element can also be easily moved between the installation position and the securing position.

In order to ensure easy limited movement between the installation position and the securing position, a positive-locking stop is formed between the drive element and the securing element to limit axial travel of the securing element between the installation position and the securing position.

By limiting travel in the direction of the securing position, the securing position can be reliably reached using a safety stop.

Limiting travel in the direction of the installation position by means of an installation stop will make it impossible to move the securing element beyond the installation stop.

Preferably, the drive element and the securing element are matched to each other in such a way that both a safety stop and an installation stop are provided. This ensures that the securing element is captively held on the drive element.

According to a further advantageous embodiment of the invention, the main body has at least one recess through which the securing element with its reach-through area axially penetrates the main body at least in certain areas.

The at least one recess of the drive element and the reach-through area of the securing element are matched in particular in such a way that the securing element is guided linearly in the at least one recess.

As a result, it is possible for the securing element to rest against the stop surfaces on one side of the drive element in the securing position. Beyond the reach-through area, in the securing element end area, on the other side of the drive element, the securing element can have a stop area that forms a positive-locking stop on the main body of the drive element in the direction of travel towards the installation position.

As a result, the securing element and the drive element are connected to each other in a captive manner and are still mounted so that they can move axially in relation to each other. Preferably, the drive element axial support structure is formed in one piece with the main body. The adjusting screw axial support structure may also be formed in one piece with the adjusting screw. This minimizes the number of components required.

The drive element axial support structure positively engages behind the adjusting screw axial support structure. The drive element axial support structure may be resilient in the radial direction, allowing the drive element to be fitted to on the adjusting screw in an axial movement in an insertion direction. The drive element axial support structure and the adjusting screw axial support structure latchingly overlap when moving in the direction of insertion, which then prevents movement of the drive element axial support structure and the adjusting screw axial support structure against the direction of insertion.

The resilient design in the radial direction is preferably achieved by designing the drive element support structure to include flexible retaining fingers with detent lugs for engaging behind the adjusting screw axial support structure.

In another advantageous embodiment of the invention, the drive element engages around the end region of the adjusting screw, driving the adjusting screw at its end region in a similar way to a conventional screw.

Because the drive element engages around and drives the end region of the adjusting screw, the adjusting screw can be produced in a simple manner and, in addition, it is easy to provide a stop in the axial direction between the drive element and the adjusting screw. The stop limits the axial relative movement between the drive element and the adjusting screw in the direction of insertion, meaning that the adjusting screw only has to be held in place against the direction of insertion by the axial support structures.

Preferably, the axial support structures are arranged in the axial direction between the drive structures and the screw thread of the adjusting screw. As a result, the drive structures are pushed through the axial support structures for installation, meaning that the outer diameter of the drive structures can be smaller than that of the axial support structures, which in turn allows the outer diameter of the axial support structures to be designed independently of the size of the drive structures.

Preferably, the securing element has a hollow cylindrical securing region. In the securing position, the hollow cylindrical securing region completely engages around the drive element axial support structure circumferentially. This completely circumferential engagement around the drive element axial support structure causes the securing element to rest evenly against the drive element axial support structure in the securing area, making it extremely stable. In another advantageous embodiment of the invention, the securing element has a cover cap at its end facing away from the screw thread of the adjusting screw. The outer diameter of the cover cap is larger than the outer diameter of the drive element. This allows the adjusting screw assembly to be inserted with the adjusting screw end first into an insertion opening of a housing of the adjusting device, in which case the insertion opening can then be covered by the cover cap. This increases protection against dirt ingress.

In a preferred embodiment, the drive element and the securing element are manufactured using a two-component injection molding process. This makes production quick and easy.

Preferably, the securing element is interlocked with the drive element in the securing position. The interlocking of the securing element and the drive element in the securing position prevents any axial movement of the drive element relative to the securing element, and vice versa.

Preferably, the adjusting device has a bevel gear that is orthogonal to the adjusting screw, which engages in the driving structure of a drive element designed as a drive wheel with bevel gearing. This allows a torque to be transmitted by the bevel gear from a direction transverse to the screw central axis.

In another advantageous embodiment of the invention, the drive element is made of a first thermoplastic material, and the securing element is made of a second thermoplastic material. The first thermoplastic material has a higher melting temperature than the second thermoplastic material. This has the advantage that both elements can be produced together in a two-component injection molding process and remain movable in relation to each other.

In order to ensure protection from external influences, the housing can be covered in some areas by the securing element when the drive assembly has been inserted through the insertion opening.

The housing can preferably consist of a travel area and a drive area. The two areas can be separated by an intermediate wall with an in particular circular intermediate wall opening. An opening is preferably provided on an upper side in the drive area of the housing, into which a bevel gear can be inserted. An insertion opening is provided on a rear side in the drive area of the housing. The insertion opening may be circular in cross-section. The insertion opening and the surrounding housing are designed such that, in the securing position of the securing element, the cover cap of the securing element covers, and in particular seals, the insertion opening.

In the area of the insertion opening, a shoulder may be formed which surrounds the cover cap.

A front region of the housing forms a displacement region in which the adjusting screw is inserted with its screw thread. More specifically, the adjusting screw is inserted in such a way that it extends through the intermediate wall opening such that the adjusting screw axial support structures and the drive structures will be arranged in the drive region. In the displacement region, a hollow cylindrical rubber seal may be provided resting against the intermediate wall and surrounding the adjusting screw.

The front end of the adjusting screw is connected to an adjustment module, with the connection being in the form of a threaded engagement. By means of an in particular rail-shaped design of the housing in the region of the underside of the housing, the adjustment module is mounted for linear displacement in the axial direction.

The threaded engagement is provided on the end of the adjusting screw facing away from the drive structures in such a way that the adjusting module is linearly displaced in the axial direction by a rotational movement of the adjusting screw.

In the securing position, the securing element preferably seals the housing by means of a radial seal and/or an axial seal. This provides increased protection against external influences in the securing position for the interior of the housing. In particular, this prevents liquids from entering the inside of the housing.

The adjusting device according to the invention can essentially be mounted by the following steps. The adjusting screw can be brought into threaded engagement with the adjustment module. From the end at which the drive structures are arranged, the rubber seal can be applied to the adjusting screw so that its second end face rests against the projection of the adjusting screw. The adjustment module can be displaced within the rail-shaped structure of the housing in such a way that the first end face of the rubber seal rests against the intermediate wall and, as a result, the drive structures and the adjusting screw axial support structures are arranged in the drive region of the housing, through the intermediate wall opening. The assembly consisting of the drive element and the securing element can be inserted into the housing through the housing opening, with the securing element being in the mounting position. The assembly can be inserted axially into the housing to such an extent that the driving structures of the adjusting screw will engage with the driven structure of the drive element and the adjusting screw axial support structure and the drive element axial support structure form a positive connection, so that the adjusting screw axial support structure and the drive element axial support structure will prevent displacement against the respective direction of insertion into the housing.

This is a reliably way of securing the adjusting screw assembly using low assembly forces.

Additional advantages, features and possible applications of the present invention will be apparent from the description which follows, in which reference is made to the embodiments illustrated in the drawings.

In the drawings,

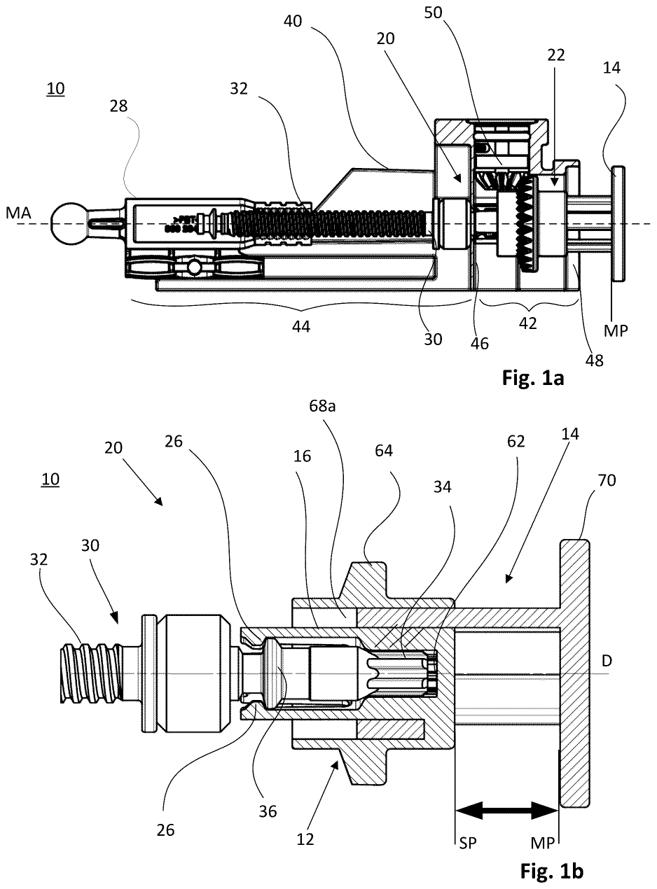

FIG. 1a is a partial sectional view of the adjusting device according to the invention, with the securing element in the installation position;

FIG. 1b is a sectional view of a detail of the adjusting screw assembly of FIG. 1a;

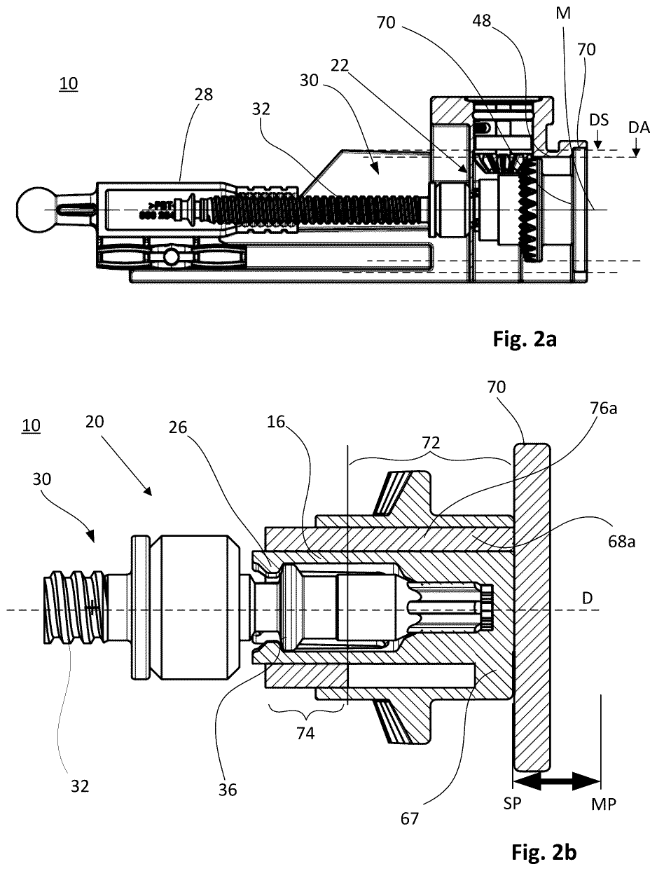

FIG. 2a is a partial sectional view of the adjusting device according to the invention, with the securing element in the securing position;

FIG. 2b is a sectional view of a detail of the adjusting screw assembly of FIG. 2a;

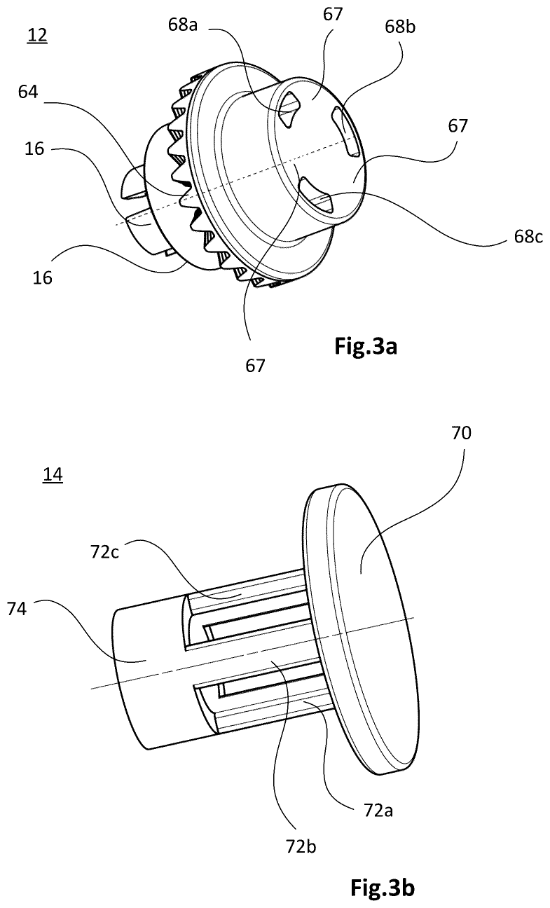

FIG. 3a is a perspective view of the drive element, and

FIG. 3b is a perspective view of the securing element.

FIG. 1a is a partial sectional view of an adjusting device 10 according to the invention.

The adjusting device 10 comprises a housing 40, an adjustment module 28 that is linearly guided in the housing 40, and an adjusting screw assembly 20. The adjusting screw assembly 10 comprises an adjusting screw 30 whose thread is in threaded engagement with the adjustment module 28.

The adjusting screw 30 has a screw central axis MA. The adjustment module 28 has an internal thread in which the screw thread 32 engages. Via a linear displacement region of the housing 40 in the area of the underside of the housing 40, the adjustment module 28 is mounted for linear displacement in the axial direction. The threaded engagement is designed such that the adjustment module 28 is displaced linearly in the axial direction by a rotational movement of the adjusting screw 30.

In addition, the adjusting screw assembly 20 comprises a drive assembly 22 comprising a drive element 12 and securing element 14, with the drive element 12 being connected to the adjusting screw 30 in such a manner that the rotational movement of the drive element 12 is transmitted to the adjusting screw 30, thereby causing the adjustment module 28 to move linearly. The adjusting device 10 comprises a bevel gear 50, from which a rotational movement, which is introduced in particular by means of a screwing tool, is transmitted to the drive element 12.

In the installation position shown, the securing element 14, which is mounted so as to be axially displaceable relative to the drive element 12, is in an installation position MP.

The housing 40 consists of a drive section 42 and a displacement section 44, which are separated by an intermediate wall 46. The bevel gear 50 is located on an upper side of the drive section 42.

On its side facing away from the intermediate wall 46, the drive section 42 has a rear side forming an insertion opening 48, through which the drive assembly 22 can be inserted.

The intermediate wall 46 has an adjusting screw opening into which the adjusting screw 30 is inserted. In this case, the adjusting screw 30 has been inserted in such a way that the rear part of the adjusting screw 30 comes to lie inside the drive section 42, and its threaded front area comes to lie in the displacement section 44.

After the adjusting screw 30 has been inserted into the housing 40 from the part on the displacement section side, passing through the intermediate wall 46, the pre-assembled adjusting screw 30 can be connected to the drive assembly 22 inserted through the insertion opening 48.

Illustrated in FIG. 1b is a sectional view of a detail of the adjusting screw assembly 20, in the connection region of the drive assembly 22 and the adjusting screw 30.

In the region of the rear end of the adjusting screw 30, drive structures 34 are fitted circumferentially on the adjusting screw 30. As viewed in the direction of the front end, a circumferential retaining projection 36 oriented in the radial direction is formed downstream of the drive structures 34.

The adjusting screw 30 is gripped by the drive element 12 both in the area of the retaining projection 36 and in the area of the drive structures 34.

At the rear end of the drive element 12, driven structures 62 of the drive element 12 engage around the driving structures 34 of the adjusting screw. The driving structures 34 of the adjusting screw 30 are designed in the manner of an external drive, with a torque being transmitted from the drive element 12 to the adjusting screw 30 via the driven structures 62. The drive element 12 has an axis of rotation D that is coaxial to the screw central axis M.

The torque on the drive element 12 is transmitted by the bevel gear 50 shown in FIG. 1a to the driving structure 64 of the drive element 12, which is designed in the form of bevel gearing.

The drive element 12 is designed as a one-piece main body, so that the rotational movement can be transmitted from the driving structure 64 to the driven structure 62 via a one-piece main body, and can thus be transmitted directly to the adjusting screw 30.

Four flexible holding fingers 16 are formed in a first end region of the drive element 12. Via their inwardly oriented positive-locking structure 26 provided on their inner side, the flexible holding fingers 16 rest against an end face of the circumferential holding projection 36 in a form-fit manner.

As a result of the flexibility of the holding fingers 16, the drive element 12, and hence also the drive assembly 22, can be pushed onto the rear end of the adjusting screw 30 in an axial movement in the assembly position, so that a latching connection is formed between the positive locking structures 26 and the holding projection 36 after it has been pushed on.

The flexibility of the holding fingers 16 in the installation position MP of the securing element 14 shown allows this latching connection to be produced in an advantageous manner without major effort.

However, this also means that the retention force is not sufficiently high to reliably counteract the axial force applied by the bevel gear 50.

In order to increase the retention force imparted by the interaction of the positive locking structures 26 and the holding projection 36, the securing element 14 is displaced in the axial direction from the installation position MP to the securing position SP, as is illustrated in the views of FIGS. 2a, 2b.

FIG. 2a shows the adjusting device 10 in a securing position thereof, in which the securing element 14 is displaced in the axial direction relative to the drive element 12 in the direction of the screw thread 32 up to its securing position SP.

The second end of the securing element 14, which is on the side of the drive element 12 facing away from the positive locking structures 26, is terminated by a cover cap 70. The drive assembly 22 is designed such that the outer diameter DS of the cover cap 70 is larger than the outer diameter DA of the drive element 12.

The inner diameter of the insertion opening 48 can therefore be dimensioned such that it is smaller than the outer diameter DS of the cover cap 70 but larger than the outer diameter DA of the drive element 12. This allows the drive assembly 22 to be inserted into the insertion opening 48 in such a way that the cover cap 70 will be able to cover the insertion opening 48. Preferably, at the insertion opening 48, the housing 40 can be designed in such a way that an edge forms around the cover cap, causing the cover cap 70 to be flush with the housing in the securing position SP. This can make it more difficult to unlock the connection manually. A sealing element can be arranged between the housing 40 and the cover cap 70. The sealing element can be designed as a radially and/or axially acting sealing element.

At its first end region facing the screw thread 32, the securing element 14 extends through the drive element 12 in the securing position SP, thus preventing unintentional release of the drive assembly 22 in the securing position SP-which is illustrated in more detail in FIG. 2b.

FIG. 2b shows a sectional view of a detail of the adjusting screw assembly 20 in the securing position.

At its first end region, the securing element 14 has a securing region 74 and a securing region 72 located between the securing region 74 and the cover cap 70.

In its securing region 74, the securing element 14 is hollow cylindrical in shape with a constant diameter. With the securing element 14 in the securing position SP, the securing region 74 engages completely the holding fingers 16 of the drive element 12 in the area of the positive locking structures 26. In this way, the positive locking of the holding fingers 16 in the radial direction prevents the holding projection 36 from expanding radially, and thus prevents the drive assembly 22 from coming loose from the adjusting screw 30.

Because the outer diameter of the reach-through region 72 is smaller than the outer diameter DA of the drive element 12, the securing element 14 will not impede the drive of the drive element 12.

In the reach-through region 72, the securing element 14 has web-shaped wall elements 76a, 76b, 76c, which are guided for linear displacement in associated recesses 68a, 68b, 68c, the cross-section of which is matched to the cross-section of the web-shaped wall elements 76 a, 76b, 76c to enable linear guidance. This linear guide allows the securing element 14 to be moved between an installation position MP and a securing position SP thereof.

Consequently, stops 67 are created in the circumferential direction between the recesses 68a, 68b, 68c in the drive element 12, which stops cooperate with the hollow cylindrical securing region 74 such that they will afford protection against loss during displacement in the direction of the installation position MP, and furthermore, a defined installation position MP can be assumed.

The outer diameter of the securing region may also be larger than the maximum outer diameter of the recesses 68a, 68b, 68c, resulting in a completely circumferential stop region between the drive element 12 and the securing element 14.

Since the cover cap 70 of the securing element 14 also results in a positive-locking stop in the direction of the securing position SP, the securing element 14 is mounted in a completely loss-proof manner in relation to the drive element 12. In the present embodiment, both the drive element 12 and the securing element 14 are formed in one piece.

Preferably, the drive element 12 and the securing element 14 are therefore manufactured together to form a drive assembly 22 in a primary molding process, for example a two-component injection molding process.

Due to the design of the adjusting device 10 according to the invention, the axial force applied by the bevel gear 50 does not act on the securing element 14, so that the securing element 14 does not have to be supported, which allows a reduction in the assembly forces and thus makes for easier assembly. The loss-proof design of the elements of the drive assembly 22 further facilitates assembly.

FIGS. 3a, 3b are a perspective view each of the individual elements, the drive element 12 and the securing element 14 resp., of the drive assembly 22.

The drive element 12 has three recesses 68a, 68b, 68c made therein. These recesses 68a, 68b, 68c are arranged in the form of partial slots on a circular path, with stops 67 being formed between the recesses 68a, 68b, 68c. At the radially outer edge, the drive element 12 is provided with a drive structure 64 for driving the drive element 12, with the holding fingers 16 with their positive locking structures 26 protruding from the first end. The drive element 12 is made in one piece.

The drive element 12 is made of a thermoplastic material.

FIG. 3b is a perspective view of the securing element 14.

As described above, at its first end, it has a hollow cylindrical securing region 74, with the web-shaped wall elements 76a, 76b, 76c essentially being wall parts of a hollow cylindrical wall. The web-shaped wall elements 76a, 76b, 76c and the recesses 68a, 68b, 68c of the drive element of FIG. 3a are matched to one another for linearly guided mounting.

The securing element 14 is formed in one piece and is in particular made of a thermoplastic material.

The melting temperature of the thermoplastic material of the drive element 12 is higher than the melting temperature of the thermoplastic material of the securing element 14.

1. An adjusting device for headlights, comprising an adjusting screw assembly, comprising an adjusting screw having a screw central axis, with the adjusting device further comprising a drive element which has a main body formed in one piece, which main body has a driving structure and a driven structure for transmitting rotational motion, wherein the driving structure and the driven structure have a common axis of rotation, and the driving structure is located radially outside the driven structure, with the drive element engaging around the adjusting screw such that the driven structure is interlockingly coupled to the adjusting screw in the direction of rotation, and the axis of rotation and the screw central axis are coaxial, said adjusting screw having an adjusting screw axial support structure and the drive element having a drive element axial support structure, wherein the adjusting screw axial support structure and drive element axial support structure are in engagement, at least in a securing position, such that the drive element axial support structure and the adjusting screw axial support structure counteract an axial relative movement between the adjusting screw and the drive element, with the adjusting screw assembly furthermore comprising a securing element, which securing element is axially slidable relative to the drive element at least from an installation position into a securing position, which securing element has a securing region which, in the securing position, interlockingly engages around the drive element axial support structure in the radial direction at least in regions such that retaining force which acts in the axial direction and is imparted by the adjusting screw axial support structure and the drive element axial support structure in the securing position is increased with respect to the installation position at least in an axial direction, wherein the securing element is arranged relative to the drive element such that the securing region is located radially between the driving structure and the driven structure.

2. The adjusting device according to claim 1, wherein said securing element is guided linearly relative to the drive element, in particular relative to the main body of the drive element.

3. The adjusting device according to claim 1, wherein a positive-locking stop is formed between the drive element and the securing element in order to limit the axial travel of the securing element between the mounting position and the securing position.

4. The adjusting device according to claim 1, wherein the main body has at least one recess, with the securing element passing through the at least one recess and being guided linearly in the at least one recess.

5. The adjusting device according to claim 1, wherein the drive element axial support structure is formed integrally with the main body and/or the adjusting screw axial support structure is formed integrally with the adjusting screw.

6. The adjusting device according to claim 1, wherein the drive element axial support structure comprises flexible holding fingers and engages positively around the adjusting screw axial support structure in the axial direction.

7. The adjusting device according claim 1, wherein the drive element engages around the adjusting screw at its end region and drives it at its end region.

8. The adjusting device according to claim 1, wherein the axial support structures are located in the axial direction between the driven structures and the screw thread of the adjusting screw.

9. The adjusting device according to claim 1, wherein the securing element has a hollow-cylindrical securing region and, in the securing position, completely surrounds the drive element axial support structure.

10. The adjusting device according to claim 1, wherein the securing element has a cover cap at the end of the securing element facing away from the screw thread of the adjusting screw, with the outer diameter of the cover cap being larger than the outer diameter of the drive element.

11. The adjusting device according to claim 1, wherein the securing element is designed to latch to the drive element in the securing position.

12. The adjusting device according to claim 1, wherein the drive element and the securing element are manufactured by a two-component injection molding process.

13. The adjusting device according to claim 1, wherein the adjusting screw is adapted to be engaged with the drive element in a latching manner in the installation position.

14. The adjusting device according to claim 1, wherein the adjusting device has a bevel gear which is oriented orthogonally relative to the adjusting screw and which engages in the drive structure.

15. The adjusting device according to claim 1, wherein the drive element is made of a first thermoplastic material and the securing element is made of a second thermoplastic material, with the melting temperature of the first thermoplastic material being higher than the melting temperature of the second thermoplastic material.

16. The adjusting device according to claim 1, wherein a sealing element is arranged between the housing and the cover cap of the adjusting screw assembly.
